(19) United States
(12) Patent Application Publication
(10) Pub. No.: US 2004/0263338 A1
(43) Pub. Date: Dec. 30, 2004

(54) Personal alarm system

(76) Inventor: Sidney I. Katz, Laguna Woods, CA (US)

Correspondence Address: STETINA BRUNDA GARRED & BRUCKER, 75 ENTERPRISE, SUITE 250, ALISO VIEJO, CA, 92656, US

(21) Appl. No.: 10/600,046

(22) Filed: Jun. 20, 2003

(51) Int. Cl. G08B 23/00

(52) U.S. Cl. 340/573.4; 340/539.12

(57) ABSTRACT

A personal alarm system may comprise a plurality of input sensors operative to selective activate a plurality of output devices wherein the output sensors and output devices are contained within a case. The output devices include a locator signal genarator may be operative to emit a locator signal to outside a zone of danger when the personal alarm system is within the zone of danger. The input sensors may be an earthquake sensor, push button switch and/or a modem.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention is directed to an alarm system which is operative to indicate to rescue personnel the location of a victim, and more particularly, to a device which emits an audible and visual signal when various dangerous situations occur.

A person encounters many different dangerous situations during their life. For example, in Los Angeles, Calif., the general population is subject to experience earthquakes, especially, given that geologist are reciting that Los Angeles is overdue for an earthquake over 8.0 on the Richter scale. During an earthquake, a person may be trapped under a mound of debris created by a falling building. In this regard, search and rescue teams are sent out to fallen buildings to search for the trapped person. Additionally, in this instance, even though the person may have prepared by purchasing a battery operated radio and first aid kit, the person's prior preparation is rendered useless because the person is trapped.

In a second example, the person may encounter a tornado in the tornado belt of the United States. In this situation, the person may be trapped in their home without time to flee to a safe location. In this instance, a search and rescue team may not be sent out for people who are unable to flee to a safe location because search and rescue teams are less willing to perform a general search without knowing whether a person is in danger. After all, the search and rescue team would not place their lives in harm's way when there is no indication that another person has been placed in harm's way.

In a third example, the person's car may stop running while the person is in a snow blizzard. In this instance, the person without heat generated from their car has encountered a life threatening situation in that the person may die if the person is unable to call for help. In some instances, the road that the person is traveling is a less traveled road thereby the person is unable to call for help from the passing motorists. In this regard, even though the person has regularly maintained their car to prevent such a dangerous situation, the regular maintenance of the car was unable to prevent from being stranded in a snow blizzard.

In a fourth example, the person may encounter a robber or a burglar. In this instance, the person is subject to the power and control of the robber or burglar. In other words, the physical threat of force from the robber or burglar has now rendered the person helpless. At this point, there is no time to make a phone call to the police. Simply put, the person must deal with the robber one on one. In this regard, the person may prepare to meet a robber by purchasing mace. However, mace requires time to shake and agility to point the mace at the robber.

Generally, people as they grow into their elderly years require greater assistance in dealing with dangerous situations such as an earthquake, tornado, snow blizzard and physical threat of force. In particular, they may not be able to get to cover during an earthquake such as the cover of a doorway. The elderly may not be able to physically overcome the robber. Alternatively, during the heat of battle with the robber, the person may be incapable of shaking and pointing the mace at the robber.

People in youth and in old age may encounter a force greater than themselves. The force may be a force of nature or a force of another person. In this regard, in each of the above-described situations, people may encounter a circumstance that renders them helpless in reaching help. The present invention provides a device and a method for which people may increase their ability to call for help or defend themselves.

### BRIEF SUMMARY OF THE INVENTION

In accordance with the present invention, a personal alarm system is provided which includes output devices and input sensors, wherein the input sensors may be operative to control the output devices. The output devices may include a locator signal generator for locating the user, through methods such as mobile phone tower triangulation based on the position of the personal alarm system. A speaker is provided, which may be manually activated or activated in response to input sensors of a receiver, to emit a sound sufficiently strong such that the sound may be heard at a distance. When used in conjunction with a radio frequency locator signal, the speaker sound may function as a local locator signal, to locate the user within a general area defined by the locator system, e.g. within a mobile phone triangulation area. The locator signal generator may be implemented to generate a cellular phone signal, a global positioning satellite signal or other equivalent signals for locating the personal alarm system.

The input sensors may include an environmental sensor, such as an earthquake sensor, a push button switch or a receiver, e.g. a modem. The input sensors may be operative to activate one or more of the output devices, e.g. the speaker alarm and/or the locator signal generator.

The output devices when activated may remain on, may be intermittent, or remain on for an initial period of time and thereafter transition to an intermittent mode until rescue personnel can come on scene.

The speaker may typically emit a sound within a 130 decibel sound within a frequency range of about 20 Hz to 20 KHz. Alternatively, the speaker may emit a sound within a hearing frequency range of a rescue animal or device.

The personal alarm system may further include a belt clip and a strap attached to the case.

The personal protection system of the present invention may be used as a stand-alone device, or as a part of a monitoring/responding network and methodology. Such a network may include monitoring devices/services operative to detect threat conditions, such as earthquakes, fires, unlawful entries, or user defined events, such as a hospitalization of a loved one. The threat condition may be communicated directly from a threat monitor to the personal protection system, e.g. by RF detection of an earthquake warning signal generated by an earthquake monitoring system. Alternatively, the threat condition may be indicated by a monitoring service, similar to a home security service, which receives information indicating a threat, evaluates the threat, and responds by contacting the user or other identified contacts as appropriate.

In practice, the monitoring service may generate a threat condition signal that triggers the speaker alarm, generates a location signal and/or generates a text message at the hand held device.

A method of providing security to a user may therefore comprise the steps of collecting real time data of dangerous situation such as earthquakes within a zone of danger, and emitting selective danger signals to personal alarm systems within the zone of danger based on collected data and other factors. Additionally, the method may comprise the step of subscribing user within the zone of danger to receive the danger signal with the personal alarm system wherein receipt of the danger signal by the personal alarm system is operative to activate selective output devices of the personal alarm system which may include a locator signal generator for locating the personal alarm system within the zone of danger, LED and/or speaker. The speaker and LED being operative to warn user and others in a local area of the personal alarm system of impending danger. The locator signal generator being operative to emit a locator signal which may be used to identify the location of the personal alarm system and the user within the zone of danger. Furthermore, the method may comprise the step of notifying rescue personnel of the location of the personal alarm system which was obtained through the locator signal.

The user may subscribe to different plans based on the zones of danger in which the user lives. For example, a user may subscribe to be notified of earthquake and/or terrorist occurrences within zones of danger defined by the nature of the occurrence.

### BRIEF DESCRIPTION OF THE DRAWINGS

These, as well as other features of the present invention, will become more apparent upon reference to the drawings wherein:

FIG. 1 is a front plan view of a personal alarm system;

FIG. 2 is a side plan view of the personal alarm system of FIG. 1;

FIG. 3 is a back plan view of the personal alarm system of FIG. 1;

FIG. 4 is an exploded perspective view of the personal alarm system of FIG. 1;

FIG. 5 is a schematic diagram of the personal alarm system of FIG. 1;

FIG. 6 is a schematic diagram of a personal alarm system incorporating a mobile phone signal generator and a modem;

FIG. 7 is a schematic diagram of a personal alarm system incorporating a GPS signal generator and a modem;

FIG. 8 is a schematic diagram of a personal alarm system incorporating a modem;

FIG. 9 is geographical map of California depicting two users and two rescue providers.

FIG. 10 is a graphical illustration of a personal alarm system in communication with a plurality of mobile phone towers;

FIG. 11 is graphical illustration of a personal alarm in communication with a rescue provider; and

FIG. 12 is a graphical illustration of a personal alarm system transmitting a location of the personal alarm system to the rescue provider.

### DETAILED DESCRIPTION OF THE INVENTION

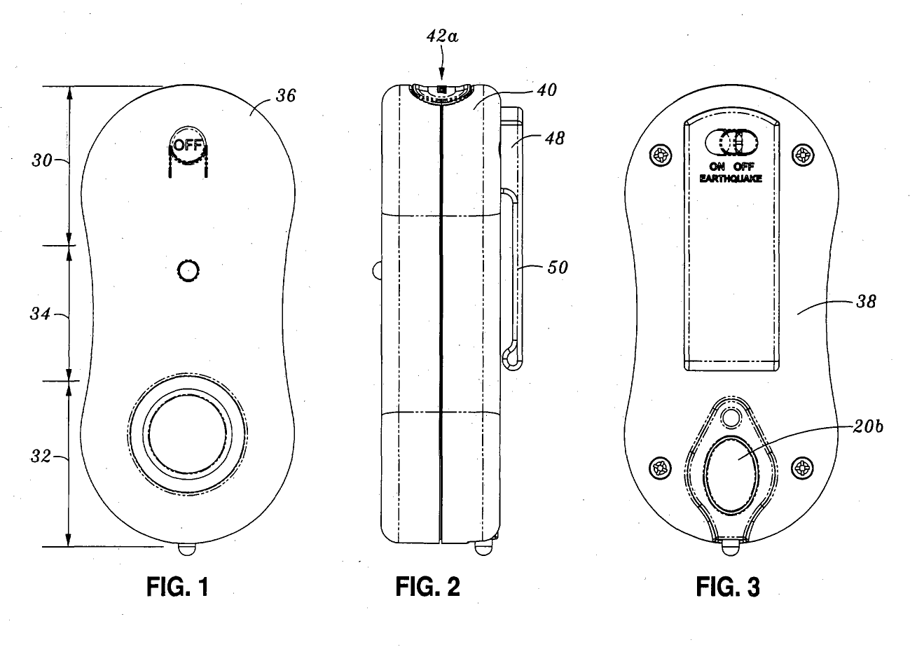

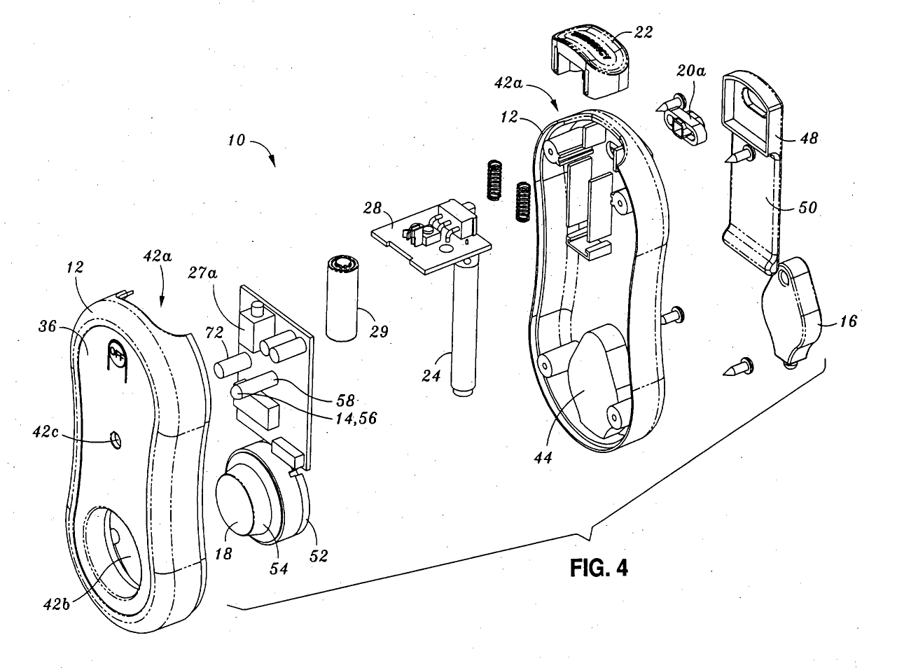

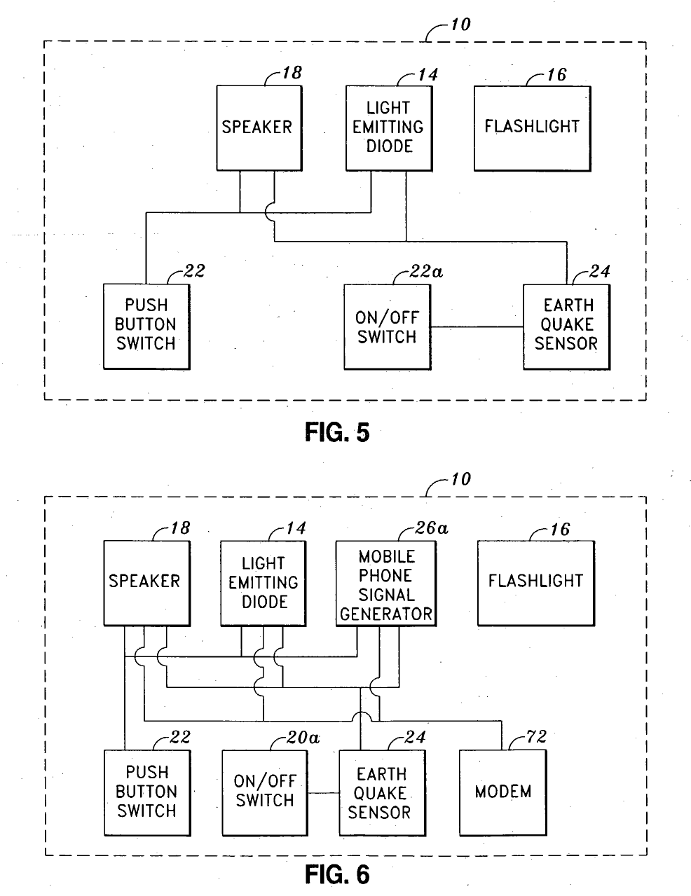

FIGS. 1-9 are for the purpose of illustrating the preferred embodiments and not for limiting the present invention. FIG. 4 illustrates an exploded view of the personal alarm system 10, and FIG. 5 illustrates a schematic diagram of the personal alarm system 10. Generally, the personal alarm system 10 comprises a plurality of output devices, a plurality of input sensors and a case 12 for holding the output devices and input sensors.

The output devices may comprise a speaker 18, light source 14 and a locator signal generator 26. The input sensor may comprise a push button switch 22, modem 72, vibration sensor 24 or an on/off switch 20. The output devices may provide a warning to those locally near the personal alarm system 10 or may provide location sensitive information to those remotely a great distance from the personal alarm system 10. The local warnings may be emitted from the output devices such as the speaker 18 and the light source 14. These local warning output devices may be activated locally by the user pushing the push button switch 22 or by the vibration sensor 24. Simply put, local activation of the input sensors emit audible and visible light to attract attention of others in the local area.

The push button switch 22 and the vibration sensor 24 may additionally activate the locator signal generator 25 which may emit location sensitive information via a cellular phone signal 78 to terrestrial mobile phone towers 78 or via a GPS signal 73 to an earth orbiting satellite. In this regard, the output devices may provide location sensitive information to people remotely outside the range of warning of the speaker 18 and light source 14. The former cellular phone signal 73 emission being more dependant on the local communication infrastructure compared to the latter GPS signal 73, which is directly transmitted from the personal alarm system 10 to the earth orbiting satellite. The local warnings output devices such as the speaker 18 and light source 14 and the location sensitive information output devices such as the locator signal generator 26 may be activated remotely by a rescue provider 70. By way of example and not limitation, the rescue provider 70 may be the United States Geological Survey (USGS) which sends out an email notification to users based on earthquake intensity and location. The email notification is receivable by the modem 72 which activates selective output devices based on the intensity and location of the earthquake. The local warning output devices are operative to warn people in the local area, and the location sensitive information output devices are operative to notify the rescue provider 70 of the location of the user. The rescue provider 70 may be an additional service provided by a governmental agency such as the USGS or a second rescue provider 70 who would relay the location sensitive information to rescue personnel such as the police department, fire department, and search and rescue teams capable of assisting the user 31.

The sound and light which emanate from the speaker 18 and light source 14, respectively, may operate to warn the user 31. For example, if the vibration sensor 24 is adjusted to detect earthquakes, then the sound and light would warn the user of an earthquake. Additionally, the sound and light would notify others in the local area that the user requires assistance. Moreover, the sound and light may operate to scare burglars. For example, the personal alarm system may be hung on a door such that the opening of the door would trigger the vibration sensor 24 and corresponding speaker 18 and light source 14.

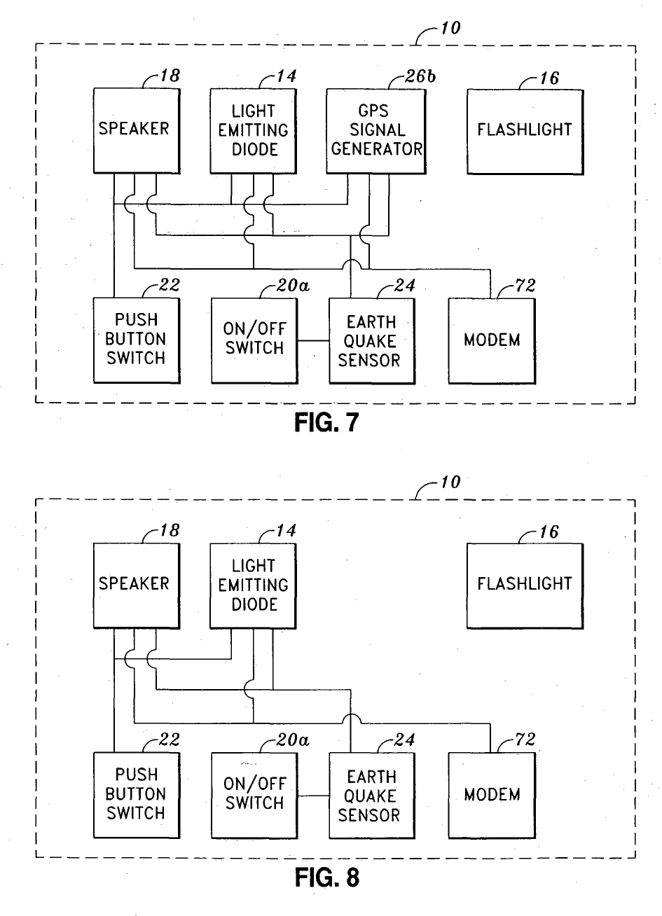

The plurality of output devices may be the light source 14, the speaker 18 and the locator signal generator 26a, b (see FIGS. 6 and 7), and the plurality of input devices may be the on/off switch 20a, the push button switch 22 and the vibration sensor 24. The output devices and the input sensors may be attached to a circuitry 28 which controls the output devices as a function of the input sensors. Additionally, the output devices, the input sensors and circuitry 28 may operate on a power source 29 such as a 12 volt DC power source.

The case 12 may be a hand-held device configured such that it is gripable by a user 31. In this regard, the overall size of the case 12 may be about 3″×5″×1.5″. As shown in FIG. 1, the case 12 defines a first end portion 30, second end portion 32 and a middle portion 34. Additionally, the case 12 defines a front surface 36 (see FIG. 1), back surface 38 (see FIG. 3) and a peripheral surface 40 (see FIG. 2). Furthermore, the case 12 defines a cavity. The first end portion 30 has an aperture 42a located on the peripheral surface 40, as shown in FIGS. 2 and 4. The second end portion 32 has an aperture 42b located on the front surface 36. The aperture 42b at the second end portion 32 may have a circular configuration which defines a diameter and may have a conical configuration which extends into the case cavity. The middle portion 34 may have an aperture 42c located on the front surface 36. The aperture 42c at the middle portion 34 may have a circular configuration which defines a diameter. The case 12 may further have a depressed area 44 on the back surface 38 of the case 12. The depressed area 44 may be located at the second end portion 32 of the case 12.

The first and second end portions 30, 32 of the case 12 may be larger in circumference compared to the middle portion 34 of the case 12. In this regard, when the user 31 grasps the case 12 at the middle portion 34, then the larger portions 30, 32 will prevent case 12 from accidentally slipping out of the hand of the user 31. The end portions 30, 32 and the middle portion 34 may be configured to generally define a figure eight. The middle portion 34 of the case 12 may further be configured with grooves (not shown). The grooves may be configured to fit the human hand. For example, there may be a total of four grooves for the fingers, and one groove in an opposing direction for the thumb.

The case 12 may be fabricated from a lightweight durable material such as plastic. The front surface 36, back surface 38 and the peripheral surface 40 may be colored to attract attention. By way of example and not limitation, the colors may be red or yellow.

The case 12 may further have a belt clip 46. The belt clip 46 defines a base 48 and a hook 50, as shown in FIGS. 2 and 4. The belt clip 46 is attached to the back surface 38 of the case 12. In particular, the base 48 is attached to the first end portion 30 of the case 12, and the hook 50 is directed toward the second end portion 32 of the case 12. The case 12 may further have a flexible strap (not shown) attached to the case 12 at the first end portion 30 on the peripheral surface 40 of the case 12.

The circuitry 28 may be configured as a circuit board electrically connected to the various output devices and input sensors. The case cavity may be sized and configured to receive the circuit board 28 with the output devices and input sensors. The circuit board 28 controls the output devices in response to the input sensors, as discussed throughout this specification.

The speaker 18 may be a speaker such as a tweeter. The speaker 18 may define a base portion 52 and a protrusion portion 54. The protrusion portion 54 is operative to produce the sound. Alternatively, the speaker 18 may be an electrostatic speaker. The base portion 52 and the protrusion portion 54 may have a circular configuration which defines diameters. The diameter of the base portion 52 may be larger than the diameter of the protrusion portion 54. The base portion 52 may be operative to secure the speaker 18 to the case 12. The base portion 52 may have flexible castellated hooks which extend beyond the diameter of the base portion 52 of the speaker 18, and the aperture 42b of the case 12 at the second end portion 32 may have a diameter slightly larger than the diameter of the base portion 52 of the speaker 18 but small enough for the hooks to latch onto the aperture 42b of the case 12. In this regard, the speaker 18 is pushed into the aperture 42b which is located at the second end portion 32 of the case 12, then the hooks will deflect inward until the speaker 18 is positioned in the aperture 42b of the case 12. At this time, the hooks will deflect outward and be hooked into the aperture 42b of the case 12. The protrusion portion 54 of the speaker 18 is directed toward the outside of the case 12 from the front surface 36.

The speaker 18 may have a frequency within the range of about 20 Hz to about 20 KHz which is the range which a human ear may hear the sound. In the alternative, the frequency range of the speaker 18 may be within the range which a rescue animal, such as a dog or some other device may detect the sound. The speaker 18 may have a decibel rating above the threshold of hearing for a human and below the threshold of pain for a human. In particular, the threshold of hearing for a human is about 0 decibels, and the threshold of pain is about 130 decibels. Preferably, the decibel rating of the speaker 18 will be about 130 decibels. The speaker 18 may be powered with a 12 volts direct current source. When the speaker 18 is activated, then the sound waves which emanate from the speaker 18 may remain on or may be intermittent. Alternatively, when the speaker is activated, then the sound waves which emanate, from the speaker may be normally on then after a set period of time such as seven minutes. The reason is that a person is likely to need help immediately once a catastrophe occurs therefore the speaker is operative to be normally on when activated so that rescue personnel may quickly locate the user 31. For example, if the average response time for the local Police Department is about five to six minutes, then the speaker will continue to emit a sound after seven minutes such that rescue personnel may locate the user. After the set period of time, the sound waves may become intermittent such that the power source of the personal alarm system may be conserved.

The light source 14, such as a light emitting diode defines a light emitting portion 56 and a base portion 58. The base portion 58 of the light source 14 is operative to secure the light source 14 to the case 12. The light emitting portion 56 is positioned through the aperture 42c of the case 12 located at the middle portion 34. Preferably, the light emitting portion 56 may protrude through the front surface 36 of the case 12, as shown in FIG. 2, or in the alternative, the light emitting portion 56 may be flush with the front surface 36 of the case 12.

The light source 14 may be operative in conjunction with the speaker 18 or may be operative independent of the speaker 18. The light source 14 may emit one or more colored lights. By way of example and not limitation, the light source 14 may emit light colors such as red, yellow and white. Preferably, the light source 14 will emit a red colored light. The light source 14 when activated may remain on. Alternatively, the light source 14 may be intermittent. Moreover, the light source 14 may remain on for a set period of time then become intermittent so as to conserve energy of the power source.

The personal alarm system 10 may further comprise a flashlight 16 such as a photon flashlight sold under the Trademark PHOTON MICRO-LIGHT. The flashlight 16 may have a base 60 and a protrusion 62. The base 60 of the flashlight 16 may have a tear drop configuration. The base 60 is operative to secure the flashlight 16 to the case 12. The depressed area 44 of the case 12 is sized and configured to receive the flashlight 16. The depressed area 44 of the case 12 may be sized and configured to make the flashlight base 60 substantially flush with the back surface 38 of the case 12, as shown in FIG. 2, and to make the flashlight protrusion 62 substantially flush with the peripheral surface 40 of the case 12, as shown in FIGS. 1-3. The flashlight base 60 is substantially flush with the back surface 38 and peripheral surface 40 of the case 12 as long as the flashlight 16 cannot be accidentally caught in the user's clothing.

The flashlight 16 may operate independently in relation to the rest of the output devices and input sensors of the personal alarm system 10 such as the light source 14 and speaker 18, as shown in schematic FIGS. 5-7. In other words, the flashlight 16 will have its own on/off switch 20b (see FIG. 3) and power source (not shown). The on/off switch 20b of the flashlight 16 may be located close to the source of the light such that the user 31 may easily identify the on/off switch 20b of the flashlight 16. The flashlight 16 may be removably engagable from the personal alarm system 10. For example, the flashlight 16 may snap into the depressed area 44. The flashlight 16 may emit various colored lights such as red, yellow and white. Preferably, the flashlight will emit white light.

The independent operation of the flashlight 16 in relation to the other input sensors and output devices provides a convenient means by which the user 31 in a dark area may maneuver to safer locations within a collapsed building. Additionally, the flashlight 16 may be used as a manually operated output device. For example, the power source 29 may have been drained of all its energy such that the output device may not emit audible, visual or electronic signals. In this instance, the user may manually activate the flashlight 16 to locally notify rescue personnel of the user's location.

As used in this description, rescue personnel is referring to governmental agencies which are for the purposes of public assistance such as the fire department, police department, search and rescue teams, and other equivalent governmental agencies. Additionally, rescue provider 70 is an intermediate organization between the user 31 and the rescue personnel. The role of the rescue provider 70 is discussed in further detail below. However, the functions and roles of the rescue provider 70 and the rescue personnel may be combined into one organization such as the police department, United States Geological Survey (USGS), or private corporation formed by the state or federal government. As such, although this description discusses the rescue provider 70 and the rescue personnel as two different organizations, it is within the scope of the present invention that one organization may provide the functions of the rescue provider 70 and the rescue personnel.

The locater signal generator 26 may be an electronic component which generates a locater signal. For example, locator signal generator 26a (see FIG. 6) may be implemented such as the locator device marketed by Cambridge Positioning Systems, or a GSM module. The locator signal generated from the locator signal generator 26a may be used to locate the locator signal generator 26a through mobile phone tower triangulation or other equivalent method. As shown in FIG. 10, the user 31 may emit a cellular phone signal to mobile telephone towers 78 a,b,c to communicate location sensitive information to rescue provider 70c through a cellular phone signal 80a,b,c. In particular, the cellular phone signal emitted by the personal alarm system 10 to the mobile phone towers 78 are retransmitted to the rescue provider 70 who triangulates the location of the user 31/personal alarm system 10 based on the strength of the transmitted cellular phone signal. Currently, mobile phone tower triangulation will provide an accurate location of the personal alarm system 10 within tens of meters. In such an implementation, the locator signal generator 26a may be operative to notify rescue personnel and/or rescue provider 70 of the approximate location of the personal alarm system 10 and user 31, within a zone of danger.

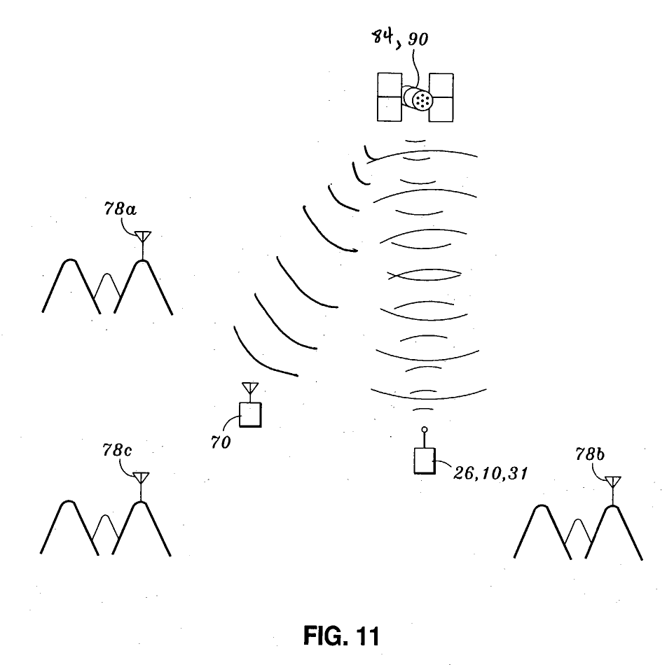

Alternatively, the locator signal generator 26b (see FIG. 7) may be an electronic component which generates the Global Positioning System (GPS) signal to a satellite. In particular, the locator signal generator 26 receives or downloads its location from the GPS 90, as shown in FIG. 11. the location signal may be transmitted to a satellite 84 and retransmitted back to the rescue provider 70 from the satellite 84. in this regard, cellular phone technology may be completely by-passed such as the mobile phone towers 78a,b,c. GPS is a worldwide satellite-based navigation system. In contrast to a GSM module, the GPS signal generator 26b if incorporated into the personal alarm system 10 may more accurately locate the user 31 and the personal alarm system 10 closer than tens of meters.

The locator signal generated from the locator signal generator 26 may be intermittent or remain on. Preferably, the locator signal generator 26 generates a locator signal that remains on at first when the locator signal generator 26 is activated. The locator signal may remain on for a sufficient period of time for a predetermined rescue provider 70a,b to be notified that the user 31 requires assistance. Additionally, the locator signal may remain on for a sufficient period of time for rescue personnel to respond to the notification for help and to arrive on scene. Then the locator signal may become intermittent, wherein the duration of intermittence is sufficient for rescue personnel to determine the location of the source of the locator signal. In this regard, the locator signal generated by the locator signal generator 26 at first alerts the predetermined rescue provider 70a,b that the user 31a,b requires help. Thereafter, the intermittence of the locator signal will conserve any power driving the locator signal generator 26a,b such that the locator signal may be generated for a longer duration of time. In other words, the intermittence of the locator signal allows the power source 29 driving the locator signal generator 26a,b to extend the length of time from when the locator signal generator 26a,b is first activated till the time when the power source 29 is out of energy such that the locator signal generator 26a,b cannot generate a sufficiently strong locator signal.

The rescue provider 70a,b may be an organization which provides services such as home security protection. The rescue provider may receive the locator signal and information from various sources such as the USGS. For example, the USGS provides an email alert based on earthquakes location (i.e., northern California and southern California) and earthquake intensity (i.e., earthquakes greater than 4.0 on the Richter scale and earthquakes greater than 3.0 on the Richter scale).

Additionally, the rescue provider 70a,b may emit a danger signal through the airwaves in response to a reported catastrophe or occurrence such as an earthquake. The danger signal may be transmitted either through a cellular phone transmission or a satellite transmission. The danger signal may contain a variety of information such as the type of danger (e.g., earthquake, tornado or snow blizzard) and location of the occurrence (e.g., southern California, northern California, Midwest, etc.). The personal alarm system 10 may receive the danger signal. For example, upon receipt of information of an earthquake, the rescue provider 70a,b may send a danger signal to the personal alarm system 10 which will alert the user 31a,b of the catastrophe that is coming. Furthermore, the rescue provider 70 may contact rescue personnel and relay location information of the user to the rescue personnel. The rescue provider 70 may contact rescue personnel through a cellular phone signal, telephone land line, or a satellite communication signal.

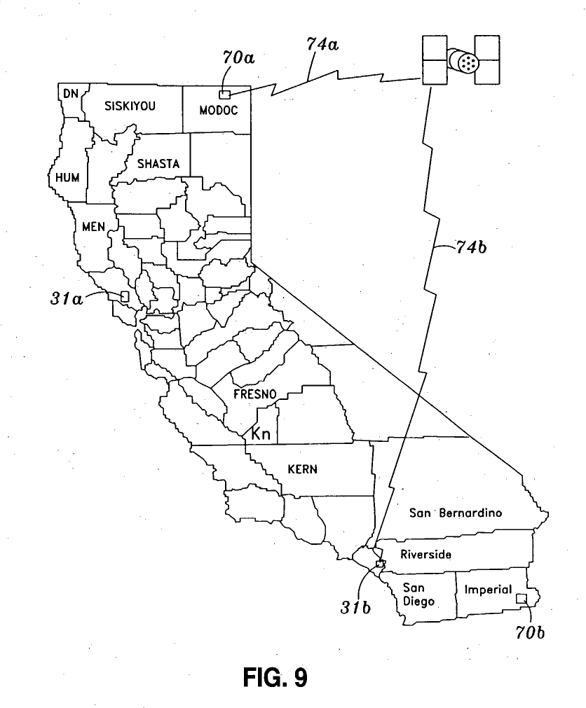

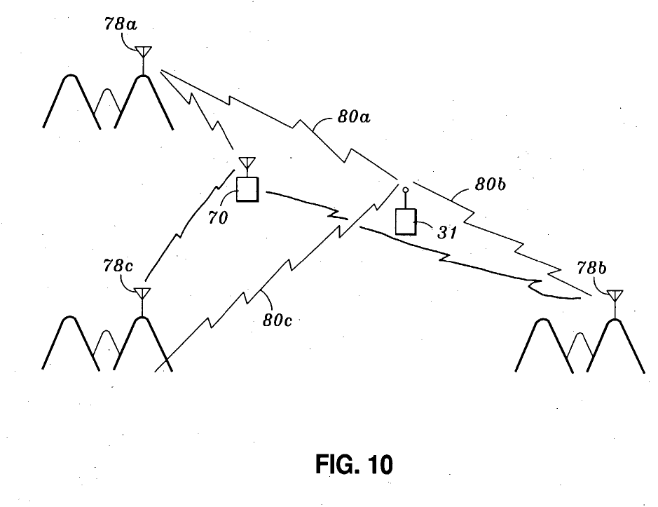

The rescue provider 70a,b may be located outside of the area in which the occurrence may occur, as shown in FIG. 9. In other words, the rescue provider 70a,b may be outside the zone of danger. The zone of danger reflects an area which is affected by a natural disaster. For example, the zone of danger for an earthquake in California may be defined as within an area which may be destroyed due to the San Andreás fault slipping, the zone of danger for a snow blizzard may be the upper mid west of the United States, or the zone of danger for a tornado may be the tornado belt in the USA. For a given geographical location, there may be a plurality of zones of danger. For example, the geographical location of Nashville may have a zone of danger for earthquakes which is different than a zone of danger for tornados.

For purposes of illustration only, as shown in FIG. 9, rescue provider 70b in southern California may provide information on occurrence in northern California, and rescue provider 70a in northern California may provide information on occurrence in southern California. As such, the rescue provider 70a would be less likely to be affected by emotion or physical limitation by occurrences in southern California. For example, a rescue provider 70a located in northern California may provide service to users in the southern California area. In this regard, if a major earthquake occurred in southern California then the rescue provider 70a located in northern California is less likely to be affected by the occurrence in southern California. In other words, the rescue provider 70a is less dependent on the communication infrastructure within the zone of danger, namely southern California. Reciprocally, there may be a rescue provider 70b in southern California to provide service to the northern California area.

The rescue provider 70a,b may also receive information from the personal alarm system 10. For example, if the input sensor detects a situation either through the earthquake sensor 24 or the push button switch 22 or any input sensor to detect a certain occurrence, then the locator signal generator sends a locator signal which is received by the rescue provider 70. Thereafter, the rescue provider 70a,b may notify a state agency to dispatch rescue personnel such as the police department, fire department or other government rescue agency to help the user 31a,b. In this regard, the rescue personnel may be generally guided to the user 31 through mobile phone tower triangulation, and specifically guided on site to the user 31 through the speaker 18 and/or light source 14. Additionally, the rescue personnel may be generally guided to the user 31 through the GPS signal being generated by the locator signal generator 26, and specifically guided on site to the user 31 through the speaker 18 and/or light source 14.

The rescue provider 70a,b may send the danger signal to the personal alarm system 10. By way of example and not limitation, the user 31b would arrange with the rescue provider 70a that the rescue provider 70a would send the danger signal to the user 31b when there is an earthquake in the urban or suburban area (i.e., within the zone of danger) in which the user 31b lives. Alternatively, the user 31a may subscribe with the rescue provider 70a such that the rescue provider 70a will send the danger signal to the user 31a when there is an earthquake in the urban or suburban area in which the user's relative 31b such as son or daughter lives. In this regard, the user 31a having a loved one 31b in southern California may subscribe with rescue provider 70a to provide information on occurrences in southern California such that user 31 a may feel assured that the user's loved one 31b in southern California is safe. Moreover, the user 31 may subscribe to different zones of danger within a geographical region. In this regard, if a certain geographical region has the danger of tornados and earthquakes, then the user 31 may subscribe with the rescue provider 70 to be notified in the case of a hurricane, an earthquake or both.

The rescue provider 70a,b may subscribe users 31a,b to a plan such that the rescue provider 70a,b would send the danger signal to the personal alarm system 10 based on the type of occurrence, location of the occurrence and intensity of the occurrence. By way of example and not limitation, the type of occurrence may be a hurricane, snow blizzard, or earthquake. By way of example and not limitation, the location of the occurrence may be western U.S., eastern U.S., northern California, southern California. By way of example and not limitation, the danger signal may be sent when there is an earthquake larger than 4.0 on the Richter scale or when there is a moderate hurricane based on the Saffir-Simpson Hurricane scale.

The rescue provider 70 may provide service at strategic locations throughout the United States. For example, at all highways that interconnect the United States and at all major cities within the United States. The service provided by the rescue provider 70 in the United States may be divided such as by zones of danger or by state. In this regard, when the user 31 travels throughout the United States, the personal alarm system may be automatically or manually registered with the rescue provider within the different zones of danger throughout the United States or by state. In this regard, the rescue provider will be able to send the danger signal to the personal alarm system to the zone of danger or state. The registration may occur by emitting a locator signal from the location signal generator, thereafter, the rescue provider will determine that the user is outside of the user's normal zone of danger or state and register the user in the current zone of danger or state. I.e., automatic registration. Alternatively, the user may communicate the user's travel plans to the rescue provider in advance of travel such that service may be transferred in accordance with the travel plans. I.e., manual registration.

The following is a discussion of the various input sensors of the personal alarm system 10. The input sensors control which ones of the output devices are activated and deactivated. Additionally, the input sensors may control the duration of activation of the output devices.

The earthquake sensor 24 may be a ball type earthquake sensor, a vibration sensor or a “P” compression wave sensor. Preferably, the earthquake sensor is the vibration sensor. The earthquake sensor 24 is electronically and physically attached to the circuitry 28, as shown in FIG. 4. The earthquake sensor 28 may have a long cylindrical configuration.

The sensitivity of the earthquake sensor 28 may be adjusted to a level to detect an earthquake yet eliminate false alarms of normal everyday usage. For example, when the personal alarm system 10 is left on a table, the sensitivity of the earthquake sensor 28 will be adjusted to activate the light source 14 and speaker 18 when an earthquake is occurring but to maintain the inactivity of the speaker 18 and the light source 14 when a person accidentally bumps the table. The vibration sensor 28 is operative to activate the light source 14 and the speaker 18. In this regard, when the vibration sensor senses the existence of an earthquake, the light source 14 will start to blink. Additionally or alternatively, when the vibration sensor 28 senses the existence of an earthquake, then both the light source 14 and the speaker 18 will be activated. The output devices may produce an intermittent audible sound and visible light when the earthquake sensor 24 activates the output devices.

The input sensor may be a GSM telephone modem 72, as shown in FIG. 6. For example, a GSM telephone modem 72 such as the AMIGO-W developed by SENAGPS. The modem 72 may be operative to receive the danger signal from the rescue provider 70a,b. As discussed above, the rescue provider 70a,b may send different signals based on a predetermined arrangement between the rescue provider 70a,b and the user 31 a,b. The danger signal may be received by the modem 72. The information in the danger signal may be operative to activate the selective output devices. For example, the rescue provider 70a and the user 31b may have a prearranged agreement that the speaker 18 and not the light source 14 would be activated in the case of an earthquake greater than 4.0 on the Richter scale in southern California. In this regard, the rescue provider 70a would emit a danger signal with such information that can be received by the modem 72 and activate the speaker 18. If the earthquake detection system is able to detect an earthquake early enough then the user 31b will know that an earthquake has occurred in southern California prior to feeling it and can take appropriate actions to protect himself or herself.

The push button switch 22 (i.e., emergency switch) is set in the aperture 42a of the case 12 located at the first end portion 30 on the peripheral surface 40. The push button switch 22 may be set flush with the peripheral surface 40 of the case 12.

The push button switch 22 may be operative to activate the output devices such as the speaker 18, light source 14 and/or locator signal generator 26. The push button switch 22 is normally open. In other words, the light source 14 and the speaker 18 is not active during normal use. When the push button switch 22 activates the output devices, the output devices such as the speaker 18 and the light source 14 may remain perpetually active. Alternatively, when the push button switch 22 activates the output devices, the output devices such as the speaker 18 and the light source 14 will initially remain active for a set period of time to alert rescue personnel, thereafter, the speaker 18 and light source 14 may become intermittent to conserve energy within the power source such that the speaker 18 and light source 14 may emit noise and light for a longer duration of time.

The on/off switch 20a is located on the back surface 38 at the first end portion 30 of the case 12. If the belt clip 46 is attached to the case 12, then the on/off switch 20a will be located on the base 48 of the belt clip 46.

The on/off switch 20a operates to deactivate the earthquake sensor 24. In other words, the earthquake sensor 24 will not activate the speaker 18, the light source 14 or any output device even if an earthquake was occurring. The on/off switch 20a is a toggle switch.

Another on/off switch may be electrically connected to all output devices and input sensors. This on/off switch is operative to disconnect the power source from all output devices and input sensors.

A discussion of the embodiments of the present invention will be discussed in relation to its uses. For example, the personal alarm system 10 may be configured such that the speaker 18 will emit a non-intermittent sound when activated by the earthquake sensor 24. In this regard, the personal alarm system 10 may be hung on a door of a home such that the speaker 18 will emit a 130 Db sound when the door is opened by a burglar.

Alternatively, the personal alarm system 10 may be configured such that the speaker 18 will emit an intermittent sound when activated by the earthquake sensor 24. In this regard, the energy of the power source is conserved for a longer duration of time thereby allowing the personal alarm system 10 to indicate the location of the user for a longer duration of time compared to a personal alarm system 10 wherein the speaker 18 emits a non-intermittent/constant sound.

The personal alarm system 10 may comprise output devices such as the speaker 18 and light source 14, input sensors such as the push button switch 22, on/off switch 20 and earthquake sensor 24, and the flashlight 16, as shown graphically in FIG. 4 and schematically in FIG. 5. The on/off switch 20 is operative to disable the earthquake sensor 24. The push button switch 22 is operative to activate the speaker 18 and the light source 14. The flashlight 16 may be operable regardless of the active or de-active state of the output devices or the input sensors. The flashlight 16 is useful when the user 31 is in an area without light which may frequently occur when a natural disaster such as an earthquake occurs.

As shown in FIG. 6, the personal alarm system 10 may comprise output devices such as speaker 18, light source 14 and mobile phone signal generator 26a, input devices such as the push button switch 22, on/off switch 20, earthquake sensor 24 and modem 72, and the flashlight 16. The on/off switch 20a is operative to disable or to enable the earthquake sensor 24. The push button switch 22 is a user 31 operated button wherein the user 31 will push the push button switch 22 to activate the output devices. The user 31 may push the push button switch 22 if the user encounters a burglar, robber or some other uninviting situation such as a rapist. The output devices when activated by the push button switch 22 emits a sound through the speaker 18, a visible light through the light source 14, and a mobile phone signal through the mobile phone signal generator 26a. If the user 31 is encountering a robber then the robber may be frightened by the sound of the speaker 18 because others may come to the rescue of the user 31. Additionally, the mobile phone signal generator 26a notifies the rescue provider 70 that the user 31 requires assistance. The rescue provider 70 may notify respective governmental agencies such as the police, fire department or search and rescue to provide assistance to the user 31 and direct the respective governmental agency to the location of the user 31. If a dangerous situation occurs within the zone of danger of an earthquake, snow blizzard or other natural disaster, then the rescue provider 70 would send a danger signal to the personal alarm system 10 which is received by the modem 72. The danger signal being processed by the personal alarm system 10 may activate selective output devices. The received danger signal may operate to activate only the speaker 18 and the light source 14, or activate all output devices such as the locator signal generator 26, speaker 18 and light source 14. In the former situation, the user may subsequently push the push button switch 22 so as to further activate the locator signal generator 26. The locator signal generator 26 is operative to emit a locator signal to the rescue provider 70. The rescue provider 70 may locate the user 31 and the personal alarm system 10 as a function of the received locator signal. The rescue provider 70 may additionally contact rescue personnel and notify the rescue personnel of the location of the user 31. In this regard, the zone of danger in which the user 31 lives is being constantly monitored by the rescue provider 70 such that the user 31 may feel secure knowing that in times of a natural disaster, the user 31 will receive a warning of a natural disaster. A dual protection is achieved in this instance because the rescue provider 70 would contact rescue personnel and notify them of the location of the user 31 if a dangerous situation occurred within the zone of danger or if the user 31 pushed the push button switch 22.

The mobile phone signal generator 26a generates a mobile phone signal. The mobile phone signal may be analyzed through mobile phone tower triangulation. However, the technique of mobile phone tower triangulation may not be sufficiently accurate for rescue personnel to locate the user 31. For example, mobile phone tower triangulation may be able to locate the user 31 within the zone of danger to a particular house but not to the specific room within the house. Therefore, the personal alarm system 10 is additionally equipped with the light source 14 and the speaker 18 such that the rescue personnel may locate the user 31 within the specific room within the house.

As shown in FIG. 7, the personal alarm system 10 may comprise output devices such as speaker 18, light source 14 and GPS signal generator 26b, input devices such as the push button switch 22, on/off switch 20a, earthquake sensor 24 and modem 72, and the flashlight 16. The personal alarm system 10 schematically shown in FIG. 7 is equivalent to the personal alarm system 10 schematically shown in FIG. 6 except that the Mobile phone signal generator 26a shown in FIG. 6 is replaced with a GPS signal generator 26b. In this regard, the rescue provider 70 may provide more accurate location data to the rescue personnel compared to the location data obtainable with a mobile phone signal generator 26a.

As shown schematically in FIG. 8, the personal alarm system 10 may comprise output devices such as speaker 18 and light source 14, input devices such as the push button switch 22, on/off switch 20a, earthquake sensor 24 and modem 72, and flashlight 16. In this regard, the rescue provider 70 such as the USGS may provide a danger signal to the personal alarm system 10 through an email or other equivalent method of communication which is receivable by the modem 72. When a natural disaster such as an earthquake occurs, the USGS may emit a danger signal containing information on the earthquake which is received by the modem 72. The personal alarm system 10 may thereafter activate the output devices.

Referring to FIG. 9, the rescue provider 70a may transmit two types of signals, namely the danger signal 74a to a satellite which orbits around the earth and redirects the danger signal 74b directly to user 31b in the zone of danger or to a mobile phone signal transmitter 76 which is located within the zone of danger and redirects the danger signal 74b to user 31b in the zone of danger.

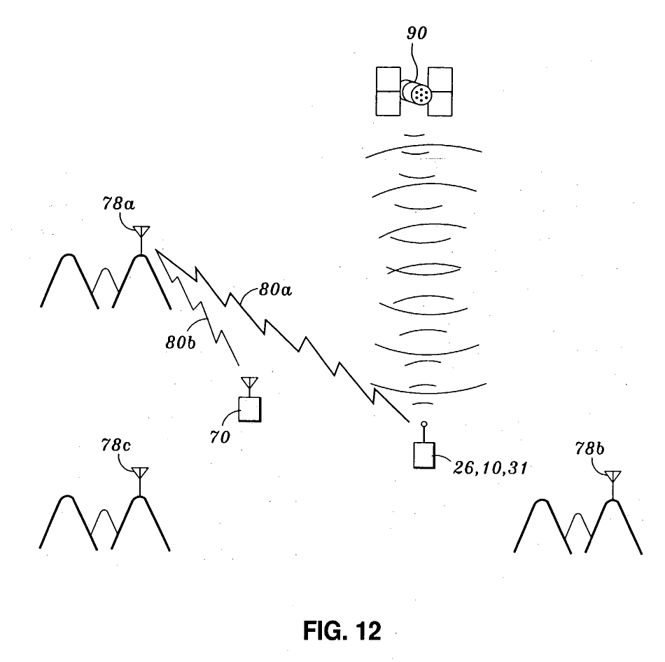

As discussed above and as shown in FIGS. 10 and 11, the user through the personal alarm system may communicate electronically with the rescue provider through cellular phone technology (mobile phone towers 78, cellular phone signal 80) and/or through satellite technology, respectively. Moreover, as shown in FIG. 12, the user 31 may receive location information from the GPS 90. The location information may be communicated to the rescue provider 70 through a cellular phone signal 80 sent to the mobile phone tower 78a and retransmitted back to the rescue provider 70 through cellular phone signal 8b. In this regard, mobile phone tower triangulation is completely bypassed.

Additional modifications and improvements of the present invention may also be apparent to those of ordinary skill in the art. Thus, the particular combination of parts and steps described and illustrated herein is intended to represent only one embodiment of the present invention, and is not intended to serve as limitations of alternative embodiments and methods within the spirit and scope of the present invention.

What is claimed is:

1. A personal alarm system carried by a user comprising:
a. output devices including:
i. a locator signal generator operative to emit a locator signal to a rescue provider for locating the user within a zone of danger;
ii. a speaker operative to emit a warning sound to notify rescue personnel of a location of the user; and
iii. a light source operative to emit a warning light to notify rescue personnel of the location of the user; and
b. input sensors including:
i. a vibration sensor operative to activate selective output devices; and
ii. a push button switch operative to activate selective output devices.

2. The personal alarm system of claim 1 wherein the locator signal generator is operative to emit location information of the user as determined by mobile phone tower triangulation through a cellular phone signal.

3. The personal alarm system of claim 1 wherein the locator signal generator is operative to emit a received GPS signal of a location of the user through a satellite communication signal.

4. The personal alarm system of claim 1 wherein the locator signal generator is operative to emit a received GPS signal of a location of the user through a cellular phone signal.

5. The personal alarm system of claim 1 wherein the speaker emits a warning sound within the frequency range of about 20 Hz to about 20 KHz.

6. The personal alarm system of claim 5 wherein the speaker emits a warning sound rated at 130 decibels.

7. The personal alarm system of claim 1 wherein the speaker emits a sound within a hearing frequency range of a rescue animal.

8. The personal alarm system of claim 7 wherein the rescue animal is selected from the group consisting of dolphins and dogs.

9. The personal alarm system of claim 1 wherein the light source emits a colored warning light selected from the group consisting of red, yellow and white.

10. The personal alarm system of claim 1 wherein the output devices remain on when activated.

11. The personal alarm system of claim 1 wherein the output devices are intermittent when activated for conserving energy of a power source of the output devices.

12. The personal alarm system of claim 1 wherein the vibration sensor is an earthquake sensor.

13. The personal alarm system of claim 12 wherein the earthquake sensor is operative to activate the speaker and light source for warning the user of impending danger.

14. The personal alarm system of claim 13 wherein the push button switch is operative to activate the locator signal generator for notifying the rescue provider of the location of the user.

15. The personal alarm system of claim 12 wherein the earthquake sensor is operative to activate the locator signal generator, speaker and light source for warning the user of impending danger and notifying the rescue provider of the location of the user.

16. The personal alarm system of claim 1 further comprising a belt clip attached to the case.

17. The personal alarm system of claim 1 further comprising a strap attached to the case.

18. The personal alarm system of claim 1 further comprising a modem input device operative to receive danger signals from the rescue provider and activate selective output devices.

19. The personal alarm system of claim 18 wherein the modem activates selective output devices based on a received danger signal.

20. The personal alarm system of claim 19 wherein the danger signal received by the modem contains information of a location and intensity of a dangerous circumstance.

21. A danger warning system comprising a microprocessor operative to collect data of dangerous occurrences of an area, sort the collected data, and transmit selective danger signals to personal alarm systems within a zone of danger.

22. The danger warning system of claim 21 wherein the microprocessor receive data from weather agencies and earthquake agencies.

23. The danger warning system of claim 22 wherein the collected data contains information as to location of the occurrence, intensity of the occurrence, and time of the occurrence to activate selective output devices.

24. The danger warning system of claim 23 wherein data of occurrences within the zone of danger is transmitted to personal alarm systems within the zone of danger to warn users of dangerous occurrences.

25. The danger warning system of claim 21 wherein the microprocessor receives data from a plurality of personal alarm systems within the area.

26. The danger warning system of claim 21 wherein the transmitted selective danger signal is transmitted to a telecommunications satellite for transmission to personal alarm systems within the zone of danger to warn users of dangerous occurrences.

27. The danger warning system of claim 21 wherein the transmitted selective danger signal is transmitted to a mobile telephone tower within the zone of danger for transmission to personal alarm systems within the zone of danger to warn users of dangerous occurrences.

28. A method of providing personal security to a user comprising the steps of:
a. collecting data of dangerous occurrences within a zone of danger; and
b. emitting selective danger signals to personal alarm systems carried by a user within the zone of danger as a function of the collected data wherein a received danger signal is operative to activate selective output devices of the personal alarm system for alerting the user of impending danger.

29. The method of claim 28 wherein the collected data is of earthquakes, tornadoes and terrorists occurrences affecting the zone of danger.

30. The method of claim 28 wherein the emitted danger signals is operative to activate a speaker and light source of the personal alarm system to notify rescue personnel of a location of the user.

31. The method of claim 30 wherein the emitted danger signal is further operative to activate a locator signal generator of the personal alarm system for locating the user within the zone of danger for notifying the rescue provider of the location of the user.

32. A method of providing personal security comprising the steps of:
a. providing a rescue provider being operative to collect data of dangerous situations within a zone of danger and to transmit selective danger signals to a personal alarm system based on the collected data;
b. subscribing users to receive the emitted danger signals with the personal alarm system; and
c. monitoring the collected data and transmitting selective danger signals to the personal alarm system based on the collected data.

33. The method of claim 32 wherein the rescue provider is outside a zone of danger and the user are within the zone of danger for reducing the dependence of the rescue provider on a communication infrastructure within the zone of danger.

34. The method of claim 32 wherein the collected data is from a locator signal generated by the personal alarm system.

35. The method of claim 32 wherein the zone of danger is defined by a natural disaster.

36. The method of claim 35 wherein the user may subscribe to different plans based on-the zones of danger in which the user lives.

37. The method of claim 32 further comprising the step of notifying rescue personnel of a location of the user based on the collected data.
